(19) United States
(12) Patent Application Publication
(10) Pub. No.: US 2007/0013816 A1
(43) Pub. Date: Jan. 18, 2007

(54) Receiver and method for reducing power comsumption in low-power mode

(75) Inventor: Christophe Martin, Paris (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/562,294

(22) PCT Filed: Jun. 15, 2004
(86) PCT No.: PCT/IB04/02023

§ 371 Date: Dec. 22, 2005

(30) Foreign Application Priority Data
Jun. 27, 2003 (EP) 033000407

(51) Int. Cl. H04N 7/16; H04N 5/63

(52) U.S. Cl. 348/730; 725/151

(57) ABSTRACT

A receiver apparatus for receiving broadcast video programs comprises a power-on operating mode wherein which a number of components of said receiver are in power-on states and a low-power operating mode for saving power when the receiver is not used wherein which at least part of said components are in power-off states. According to the invention, the receiver comprises a low-power circuit for switching the receiver from one current operating mode to the other operating mode, comprising a bi-stable circuit for storing the states of said components in each of the two operating modes and for detecting a switch command for switching the receiver from the current operating mode to the other operating mode, in order that upon detection of the switch command the bi-stable circuit triggers the components from their current states into their other states.

### FIELD OF THE INVENTION

The invention generally relates to digital transmissions. It particularly relates to a receiver apparatus and a power control method for reducing power consumption on standby mode.

The invention advantageously applies to television broadcasting receivers also called set top boxes (STB).

### BACKGROUND OF THE INVENTION

European patent application number 1 1608 991 describes a receiving apparatus and a power control method as mentioned in the opening paragraph, which permit standby power consumption to be reduced. According to this document, an extra microprocessor, denoted human interface HI microprocessor, is used to manage the power saving of most components by turning off a power switch inside the main power supply. Part of the power consumption is saved with this mechanism. However, using an extra microprocessor with appropriate software to manage power saving renders the procedure expensive.

### OBJECT AND SUMMARY OF THE INVENTION

It is an object of the invention to provide cost-effective means to reduce standby power consumption in a receiver, avoiding the use of an extra microprocessor.

According to the invention, a receiver apparatus and a power control method are described for switching the receiver in a power saving mode. The receiver comprises a low-power unit including a bi-stable circuit for storing the power-on and power-off states of at least part of the components of the receiver and for detecting a power switch command, in order that upon detection of said power switch command the bi-stable circuit causes said part of the components to be switched from their current states to their other states.

The use of an extra microcontroller is avoided by using a bi-stable circuit instead for triggering the power-on and power-off sates of the receiver's components. Advantageously, this bi-stable circuit, which needs to be powered-on even in power saving mode, consumes less power than an extra microcontroller, thus leading to an additional power saving compared to the state of the art.

### BRIEF DESCRIPTION OF THE DRAWINGS

The invention and additional features, which may be optionally used to implement the invention, are apparent from and will be elucidated with reference to the drawings described hereinafter, wherein which:

FIG. 1 is a bloc diagram for illustrating a broadcasting system comprising a receiver apparatus according to the invention,

FIG. 2 is a schematic diagram illustrating the main features of the invention,

FIG. 3 is schematic diagram illustrating an embodiment of the invention.

### DETAILED DESCRIPTION OF THE DRAWINGS

The following remarks relate to reference signs. Same letter references in all Figures designate same entities.

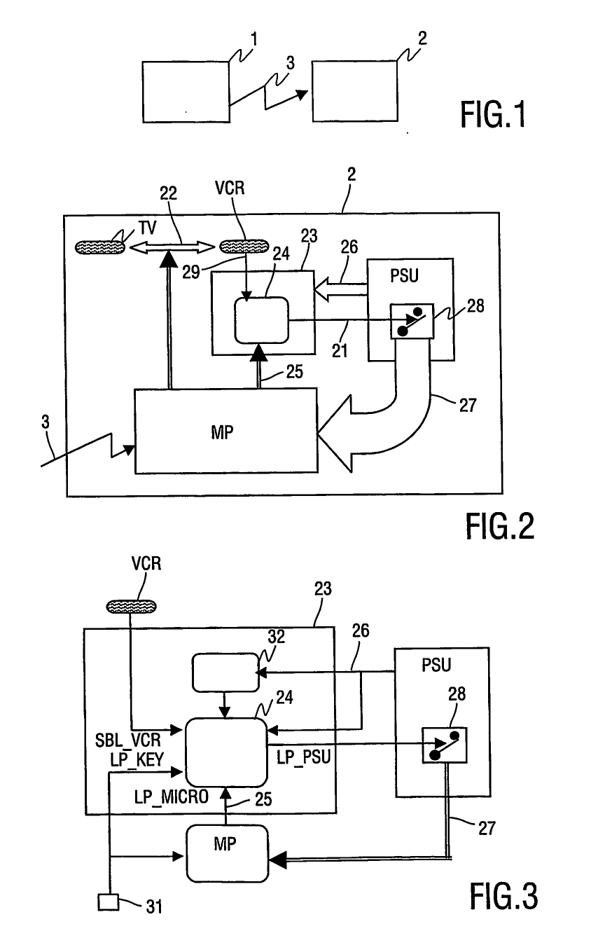

FIG. 1 illustrates basic features of a broadcasting system. It comprises a transmitter part 1, at least a receiver apparatus 2 and a transmission medium 3. The transmission medium may be a satellite, cable or terrestrial link enabling the receiver apparatus to receive television or video programs. The receiving apparatus may include, for example, a digital television receiver or a STB (set top box) connected to a television set. Other peripherals may also be connected to the STB, like for example, a VCR (Videocassette Recorder) or a DVD (Digital Video Disc) player.

Many components inside the receiver, like the tuner or the decoder, don't need to be powered on when the receiver is not used. Therefore a standby or sleeping mode has been defined in order to switch off the power supply of several components when the receiver is not used to receive, display or record broadcast programs.

However, the receiving apparatus need always be at least able to perform basic operations relating to the loop through mode between the VCR or DVD player and the TV set for enabling a user to play a videocassette or videodisc without previously starting the STB. Therefore, even in standby at least some components of the receiver may need to be energized.

FIG. 2 shows the features of a receiver according to the invention for saving power in standby or low-power mode. The receiver comprises:
a main unit MP comprising a number of components for receiving broadcast programs from a satellite, cable, terrestrial or any transmission system, and for supplying audio and video data to the TV, VCR or DVD peritelevision connectors 22, also called scart connectors, the components having power-on and power-off states to be set depending on the operating mode of the receiver,
a low-power unit 23 comprising a bi-stable circuit 24 for storing the states of the components in each of the two operating modes and for detecting a switch command 25 for switching from the power-on operating mode to the low-power operating mode, in order that upon detection of said switch command the bi-stable circuit causes the components to be switched from their power-on states to their power-off states,
a power supply unit PSU for supplying power to the main and low-power units via appropriate connections 26 and 27, the power supply unit comprising switching means 28 connected to the part of the components inside the main unit (for example the decoder, the tuner, etc.) which need not be in power-on state when the receiver is in the low-power operating mode, for switching these components from their current power-on operating mode states to their low-power operating mode states upon detection of the power switch command 25 by the low-power unit 23.

Once the receiver is in low-power mode, at least a slow blanking signal 29 from the VCR scart must enable the receiver to switch to the power-on state for the user being able to play a videocassette. A dedicated user interface key (not shown in FIG. 2) can also be used to trigger the bi-stable logic to switch all components to their power-on states.

FIG. 3 shows an embodiment of a low-power unit 23 according to the invention enabling the receiver to switch from the power-on mode to the low-power mode and vice versa. A very low amount of components is needed to realize the low-power circuit. A quad NAND gate Integrated Circuit mounted as a flip-flop, four transistors, eleven resistors, three capacitors and one diode can be used. A very little area is needed on the Printed Circuit Board for this circuit (about 1 cm×2 cm).

The circuit has at least three inputs:
a slow blanking input SBL_VCR from the VCR scart,
a signal LP_KEY coming from a front panel key 31 dedicated to the low-power mode and
a signal LP_MICRO coming from the main unit MP used to switch the circuit in low power mode.

The LP_KEY signal is also connected to the main unit MP in order to be permanently read. Another signal having the same result as the LP_KEY signal can be provided by the main unit MP and be triggered by a timer for the purpose of automatically saving energy when the receiver is not used for a predetermined period of time.

The circuit has one output: a signal LP_PSU sent to the PSU in order to switch off the voltages of the parf of the components which need not be powered-on during standby mode. In a preferred embodiment, all voltages are switched off, except the one used to supply voltage to the low-power circuit, which can be for example powered with a permanent +3,3 Volts coming from the PSU.

The power supply PSU has on each voltage output a switch 28 that can be open when the LP_PSU signal is activated. This PSU should also have a good efficiency and a low primary consumption during a low power mode.

A reset circuit 32 can be used to force the PSU to switch on every voltage outputs so that all components are in power-on states

The low-power circuit operates as follows. During the power up of the product, a reset circuit can be used to force the PSU to switch on every voltage outputs so that all components are in power-on states. This reset circuit presets the flip-flop into its nominal position; the LP_PSU signal at the output of this flip-flop is then deactivated. When the user needs to switch the product in low-power mode, he presses the LP key 31 on the front panel. A microprocessor, denoted the main microprocessor, inside the main unit MP detects the key press by reading the LP_KEY signal and switches the LP_MICRO signal when every software task is completed. Activation of this signal triggers the flip-flop and puts the PSU in low-power mode by mean of the LP_PSU signal. At that time the product has a very low consumption, about 0.6 Watts. The new status is memorized inside this flip-flop. Now if the SBL_VCR or LP_KEY are activated (for example if the user presses again the front panel key), the flip-flop will be triggered and the circuit comes back in normal mode as previously. The PSU will receive a deactivation of the LP_PSU and will switch on every voltage. The main microprocessor will start booting and can detect if a slow blanking has been activated on the VCR scart. If it is the case it can enter in loop through VCR to TV mode; if not, it can enter in normal mode playing internal video.

Advantageously with this method, not only the power supply of the front-end and demodulation parts of the main unit but also the one of the main microprocessor can be cut down in low-power mode, which is very efficient.

The drawings and their descriptions hereinbefore illustrate rather than limit the invention. It will be evident that there are numerous alternatives, which fall within the scope of the appended claims.

1. A receiver apparatus comprising a number of components having power-on and power-off states, the receiver comprising a low-power unit for switching at least part of the components from one of said states, denoted current state, to the other state, the low-power circuit comprising a bi-stable circuit for storing the power-on and power-off states of said part of the components and for detecting a power switch command, in order that upon detection of said power switch command the bi-stable circuit causes said part of the components to be switched from their current states into their other states.

2. A receiver apparatus as claimed in claim 1, wherein which the bi-stable circuit is arranged so that said part of the components are all triggered in the same states upon detection of said switch command.

3. A receiver apparatus as claimed in claim 1, wherein which said low-power unit comprises a reset circuit for resetting the states of said components in their power-on states.

4. A receiver apparatus as claimed in claim 1, wherein which the components are included in a main circuit for receiving broadcast programs and for supplying audio and video signals, the main circuit being connected to the low-power unit and to a power supply unit for supplying power to the components, the power supply unit comprising switching means connected to at least said part of the components of the main circuit for switching said part of the components from their current states into their other states upon detection of a power switch command by the low-power circuit.

5. A receiver apparatus as claimed in claim 4, wherein which all components of the main circuit are switched to a same state upon detection by the low-power unit of a power switch command.

6. A receiver apparatus as claimed in claim 4, wherein upon detection by the low-power unit of a power switch command, the current states of the components being the power-on state, the power supply unit only supplies the low-power unit.

7. A receiver apparatus as claimed in claim 1, comprising a front panel key to be pressed by a user to trigger said power switch command.

8. A receiver apparatus as claimed in claim 1, wherein which said power switch command to switch said part of the components to their power-off states is automatically triggered after a predefined timer has lapsed.

9. A method of power control in a receiver comprising a number of components, which need to be supplied by a power supply unit, the receiver having a power-on operating mode wherein which said components of the receiver are in a power-on state and a low-power operating mode wherein which at least part of said components are in a power-off state, the receiver comprising a low-power unit for switching the receiver from one operating mode, denoted current operating mode, to the other operating mode, the method comprising the steps of:
storing the states of said components in each of the two operating modes,
detecting a power control signal,
upon detection of said power control signal, switching said part of the components from their current states to their other states.

10. A method as claimed in claim 8, wherein at least part of the components include all components except the components of the low-power unit.
